(19) United States
(12) Patent Application Publication
(10) Pub. No.: US 2005/0245259 A1
(43) Pub. Date: Nov. 3, 2005

(54) Associating subscriber information between protocols

(76) Inventors: Michael R. Kelly, Omaha, NE (US); Tiffany A. Moore, Omaha, NE (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/833,512

(22) Filed: Apr. 28, 2004

(51) Int. Cl. H04Q 7/20

(52) U.S. Cl. 455/435.1; 455/1

(57) ABSTRACT

A communications device embodiment includes a processor, memory, and program instructions executable by the processor. The memory includes a link ID that associates a number of network keys that each provides access to a different network protocol for a particular subscriber. Program instructions are provided to the memory and executable by the processor to select a first network key from the number of network keys and to query whether the first network key is registered in the first network type.

### INTRODUCTION

The worldwide wireless industry has several different network protocol types that are being used in various parts of the world. This situation is partly due to the proliferation of wireless technology in various parts of the world before a standard protocol was established. As such, several systems each having a different protocol now exist in various distinct locations, such as Asia, Europe, and the United States, to name a few. Additionally, network protocols are being created and adopted throughout the world to support advances in the speed of the networks and the functions that the networks can provide.

With each advance of a new protocol into the industry or the advance of an existing protocol into a new coverage area, the infrastructure providing communication between devices must be changed to accommodate the new or newly available protocol. In order to change the infrastructure without requiring all of their subscribers to purchase devices compatible with a protocol not currently available in their area, many providers are trying to update their existing infrastructure to support both their existing protocol and a newly available protocol, at least temporarily.

Another approach has been to overlay a new protocol infrastructure over an area covered by an existing protocol. In this way, both, the users of the existing protocol and the users of the newly available protocol, can utilize their devices in the same or similar coverage areas. Based upon this approach, currently, several networks supporting voice, data, and/or video formats oftentimes overlap each other, at least partially.

Where networks having different protocols communicate with each other, several issues arise with respect to communicating between the different network protocols. For example, each network has different ways of identifying subscribers to their network. For instance in an American National Standards Institute (ANSI) type network, each subscriber is given a ten digit telephone number called a Mobile Directory Number (MDN). The MDN is a directory listing telephone number (e.g., dialable number) that is dialed to reach a communications device, such as a mobile device.

The MDN is usually associated with a Mobile Identification Number (MIN) in a wireless device, such as a telephone. The MIN is a unique registration number associated with a communications device when the device is registered on a particular network that is serving the subscriber. MINs are used internally by the network and are usually transparent to the subscriber. The MIN is associated with the MDN by the network serving the subscriber and is used to identify the subscriber within the serving network.

In some networks, such as various networks within the United States and Canada, the MDN and MIN can typically be the same value for a particular subscriber to a particular network. When a subscriber to a network is roaming into another network within the United States or internationally, oftentimes the result is that the MDN is different from the MIN.

In such cases, other identification numbers are used by different network types and have been given different names to describe them. For example, a subscriber identifier in a GSM network is called an International Mobile Subscriber Identifier (IMSI) and the directory listing telephone number is called a Mobile Station Integrated Services Digital Network number (MSISDN).

An MSISDN provides similar functionality to that of the MDN described above, but is used by the GSM protocol. In some cases the MDN and MSISDN can be the same identifier. However, in many cases, the MDN and MSISDN are different and, therefore, the use of a MDN from one protocol, for example, cannot be used to identify a subscriber or the MSISDN for that subscriber in a different network. This situation occurs most often when a subscriber is roaming internationally out of their home network. The situation also arises when subscribers on different networks have been given the same MSISDN/MDN. In such situations a subscriber cannot have the same identifier in both network types because the identifier is already in use by another subscriber.

The IMSI is an identification code for a mobile device similar to a MIN. In a GSM type network, each subscriber can have one IMSI that is associated with several MSISDNs for a particular subscriber. The same can be true with respect to a subscriber having one MIN associated with one or more MDNs in an ANSI network. These examples from ANSI and GSM are provided as illustrations as to how different identifiers are used by networks. Similar types of identifiers are present in networks other than ANSI and GSM and, as stated above, the invention is not limited to these two network types.

Identifiers such as the IMSI and the MIN are commonly referred to as network keys. In various networks operating in the world today, the network keys can have different formats, such as the number of digits, the meaning of each digit, and the like.

These differences in format can make it difficult for different network protocols to communicate with each other. To overcome this difficulty, it has been suggested that one of the currently available key formats be adopted as a universal key for all network protocols or that a new key format be created that can be used for all networks. However, since the formats can be different, a single key cannot be assigned to a subscriber for all network protocols.

Additionally, wireless communications networks are constantly evolving in areas such as: the formats of signal transmission, the kinds of communications, and the number of services they provide. For example, wireless networks have added the capability to transmit packet-based data for mobile wireless communications purposes. In this way, the convergence and interoperation between back-end computing systems (such as servers and data stores) and front-end user devices (such as PDAs and mobile wireless telephones) have been enabled. Such interoperation, for example, allow front-end user devices to access digitized voicemail, order processing, and Internet portals, to name the functions of a few types of back-end computing systems.

As systems evolve, from 2G, to 2+G, to 2.5G, to 3G networks and beyond, the protocols used to implement these networks are also evolving and therefore situations arise where different network keys are implemented. Wireless network operators are interested in using their legacy infrastructure with these evolving networks, however, by using different network keys, the network protocols can have difficulty locating and connecting with a subscriber.

### BRIEF DESCRIPTION OF THE DRAWINGS

FIG. 1 is an exemplary embodiment of a system having multiple network keys in a link file.

FIG. 2 is an illustration of exemplary parts within a link file and two networks.

FIG. 3 is a block diagram illustrating an embodiment of a system including a serving network and a target network.

FIG. 4 is a scenario diagram illustrating an embodiment of the communication between a first network and a second network for locating a communications device.

FIG. 5A illustrates an example of a table of network types.

FIG. 5B illustrates an example of a logic table for the cancellation of different network types.

FIG. 5C illustrates an example of a priority table for selection of a network type to be queried.

FIG. 5D illustrates examples of functions that can be utilized with a link ID.

FIG. 6 is a block diagram of a method embodiment for wireless operation between first and second networks.

FIG. 7 is a block diagram of another method embodiment for wireless operation between first and second networks.

### DETAILED DESCRIPTION

Embodiments of the present invention communicate with devices on networks of different types through use of a link structure that can be accessed to provide network keys for the variety of networks that are available to a particular subscriber. In this way, a communications session can be created between the requesting communications device or network and any of a number of networks upon which a target communications device is registered.

For example, a requesting subscriber on a serving network wants to contact another (target) subscriber that may be a subscriber on the serving network or on another network. When a user subscribes to a network, one or more of the user's communications devices is registered on the serving network and is assigned a network key for the network.

In order for the requesting subscriber to connect with the target subscriber, the requesting subscriber's communications device requests a connection with the target subscriber's communications device by providing the directory listing telephone number or other identifier that has been assigned to the target communications device when it was registered with a network. The serving network can use the identifier to locate the network key associated with the identifier. In various embodiments described herein, a link structure can associate all of the network keys assigned to a subscriber's registered communications devices when the subscriber registered on each network.

When a call is initiated by a requesting communications device, the network type that is serving the requesting subscriber can check to see if the target communications device is accessible through the serving network. If the target communications device is registered but inaccessible, or is unregistered, the serving network can attempt to access the records of other network types to see if the target communications device is registered on one of the other networks.

The embodiments of the present invention allow access to a link structure, such as a link file which, as described above, includes network keys for accessing the subscriber information on network types on which the subscriber is registered. This also allows for the network key information to be present in a location for a number of network types, thereby providing greater ease in locating the network keys and allows for keys to be added, changed, or canceled more easily. In various embodiments, the process of creating the connection through accessing a link structure can be transparent to the subscriber.

As one of ordinary skill in the art will appreciate upon reading this disclosure, a network infrastructure can support a communications session. Communications sessions include, for example, data transfer, voice transfer, video transfer, and a mix of data, voice, and/or video, to name a few.

The infrastructure is operable to initiate a communications session from one communications device (requesting communications device) to another communications device (target communications device). A communications device can be any interface equipment used to receive and transmit information to and/or from a user. Examples of communications devices include mobile devices, handsets, or computer terminals, among others.

Communications sessions can be initiated from communications devices that are operable on one or more of a variety of serving networks and can be received on devices that are operable on one or more of a variety of target networks. Further, the communications session can be initiated on any network available including, but not limited to networks such as: on wireline networks like Publicly Switched Telephone Networks (PSTN), and on wireless networks like Global System for Mobile communications (GSM) networks, American National Standards Institute (ANSI) networks, Universal Mobile Telecommunication System (UMTS) networks, and Enhanced Data for Global Evolution (EDGE) networks, Public Wireless Local Area Networks (PWLAN), and/or Internet Protocol (IP) networks, to name a few.

FIG. 1 is an exemplary embodiment of a system having multiple network keys in a link file. This example illustrates two networks 101 and 103 of different types (e.g., ANSI and GSM) and a link file 102 containing keys for a number of network types.

In this example, a subscriber in the ANSI network 101 has been assigned a MIN of 1111111111 and an MDN of 4021111111. When a requesting subscriber requests the MDN 4021111111 (e.g., by dialing the number into the requesting communications device), program instructions within the ANSI network execute to identify that the MDN 4021111111 is assigned to a subscriber having the MIN 1111111111. A link ID has also been assigned to the subscriber and can be associated with the MIN and/or MDN assigned to the subscriber.

Program instructions within the serving network can execute to check its records to see if the MIN 1111111111 is registered and if the target communications device is accessible. If the target communications device is accessible, the call can be directed to the target subscriber. If the target communications device cannot be accessed by the serving network, then the link file can be accessed and a connection on a different network type can be attempted. In various embodiments, the serving network can access the link file initially to identify the network key for the serving network.

In the example of FIG. 1, program instructions within the serving network 101 have executed to assign link ID 47 to a target subscriber which indicates the location of the subscriber's network keys within the link structure. A link structure, as discussed herein, includes a number of network keys in a database or other storage format. The network keys can be in a file having a number of subscriber records therein or each subscriber record can be in a different file.

In various embodiments, the link structure can also include program instructions executable to add, organize, update, and/or remove network keys and link files. The link structure can include program instructions which execute to identify a link file or a portion of a link file having the subscriber's information therein. In various embodiments, the link structure can be or can include the link ID.

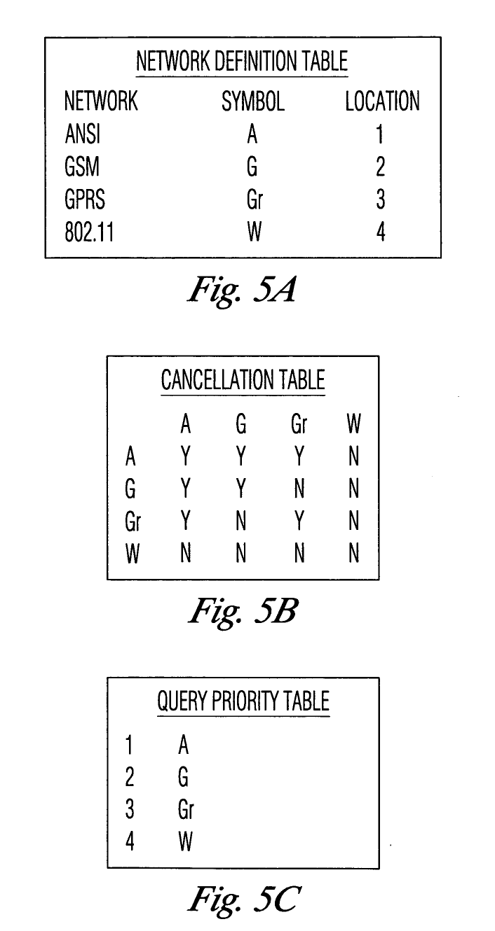

In the example of FIG. 1, the link file includes network keys for four network types. In this embodiment, the network types are identified by a symbol provided in the definition table shown and described with respect to FIG. 5A. However, the network types can be identified in various manners and can, for example, be identified by the order they are organized in the link file.

The network types shown include an ANSI (A), GSM (G), GPRS (Gr), and another Wireless network (W) based upon the wireless 802.11 standard as the standard is known and understood in the art. The network types shown are examples of various network types and more, less, or different network types can be present in the link file. Additionally, the network keys shown in FIG. 1 are all the same length, however, network keys of different lengths can be included in the link file.

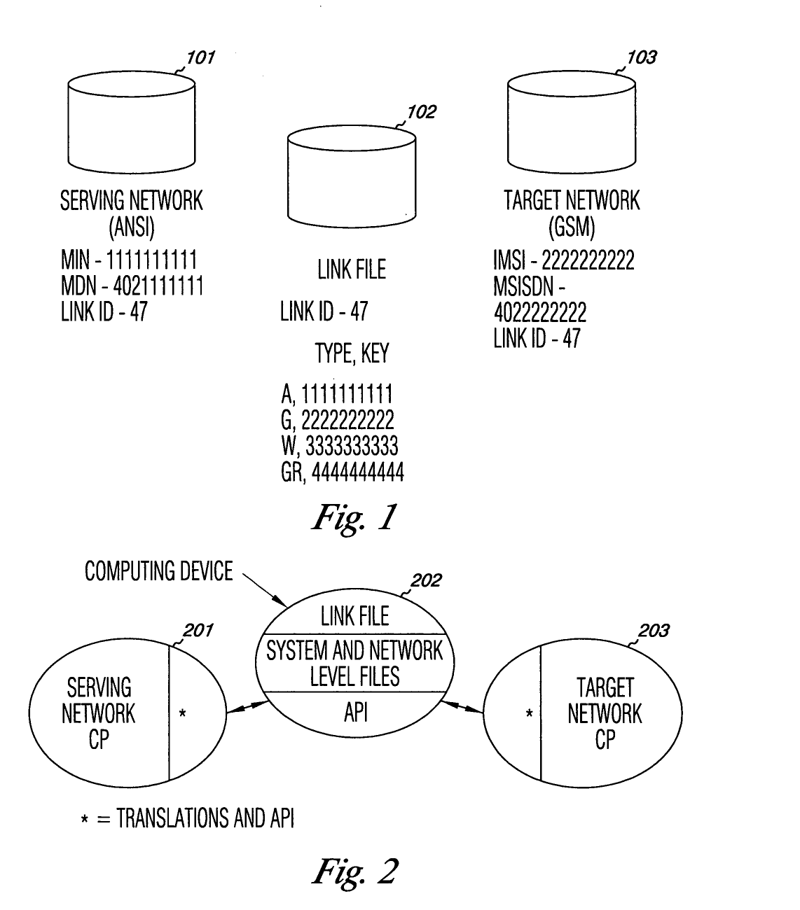

FIG. 2 is an illustration of exemplary parts within a link file and two networks. The system of FIG. 2 includes an ANSI network 201, a link structure 202, and a GSM/GPRS network 203. The ANSI network 201 includes an ANSI call processing component (ANSI CP) and associated translation and API program instructions which can execute to translate and communicate with other network types and devices outside the network on which the instructions reside. In the embodiment shown in FIG. 2, the GSM/GPRS network 203 also includes a GSM/GPRS call processing component (GSM/GPRS CP) and associated translation and API program instructions which can execute to translate and communicate with other network types and devices outside the network on which the instructions reside.

The link structure 202 includes a number of link files, a number of system and network level files, and a number of APIs. The system and network files of the link structure 202 are program instructions that execute to allow for management of the link files as will be described in greater detail below with respect to FIGS. 5A-5D.

The system and network files of the link structure 202 also are executable to allow for the interaction of the link structure 202 with the networks 201 and 203 among others. Although the link structure has been illustrated in FIGS. 1 and 2 as being independent from networks 101/201 and 103/203, the link structure can be located within one or more components of the illustrated networks or other networks not shown, or can be within an independent device or network.

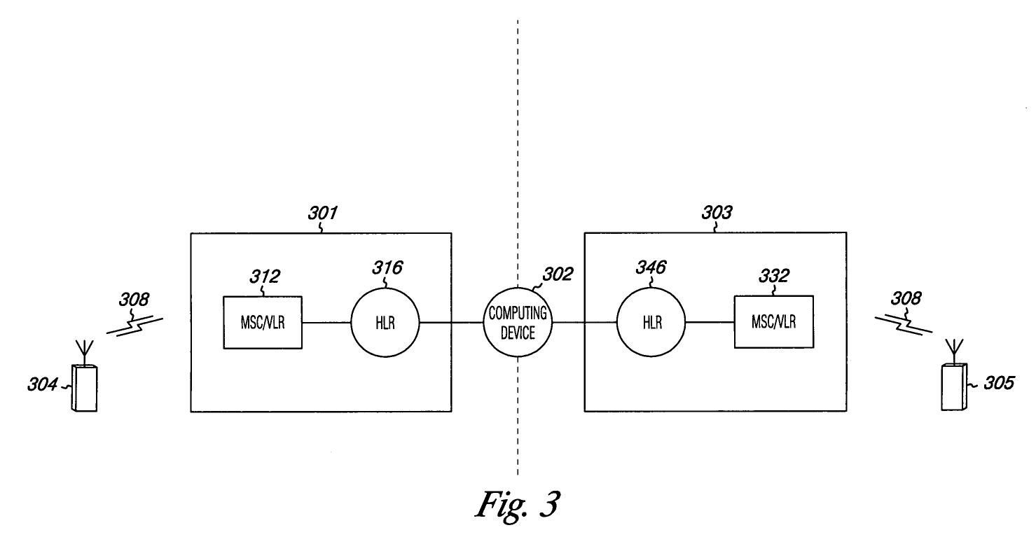

FIG. 3 is a block diagram illustrating an embodiment of a system including a serving network and a target network. FIG. 3 illustrates an embodiment of a connection between a requesting communications device 304 and a target communications device 305 over the serving network 301 and the target network 303.

In the embodiment shown in FIG. 3, a requesting communications device 304 communicates, through an ANSI network infrastructure 301 acting as the serving network, with a target communications device 305 that is utilizing a GSM network infrastructure 303. The communication between the serving network 301 and the target network 303 is provided through a computing device 302. In the embodiment shown in FIG. 3, the computing device 302 provides the link structure components similar to those described in component 202 of FIG. 2 (e.g., link file, network and system level files, and APIs for implementing the link structure and interacting with the different networks).

Those of ordinary skill in the art will understand that the communication devices, servers, and other computing devices discussed herein, such as a server or computing device in serving network 301, computing device 302, and communications device 304, include one or more processors and memory therein for the storing and execution of program instructions. Memory can include non-volatile and volatile memory such as Flash memory, Read Only Memory (ROM), Random Access Memory (RAM), and optical memory, among others.

The communications devices that can be utilized can be fixed or mobile devices and can have several networks through which a communications session can take place. In FIG. 3, the networks shown are operable to be utilized as mobile networks and the structures of embodiments of these networks are described in detail below. However, the invention is not limited to the structures shown.

In the serving network 301 of FIG. 3, a requesting communications device 304 communicates with a mobile switching center (MSC) 312 through a base station having an antenna (not shown). Wireless telecommunications networks, such as the example shown in FIG. 3, include an MSC that is connected to a plurality of base stations that are dispersed throughout the geographic area serviced by the network.

The geographic area serviced by a wireless telecommunications network is partitioned into a number of spatially distinct areas called “cells.” Each MSC is responsible for, among other things, establishing and maintaining calls between communications devices, such as between a mobile device and a wireline terminal, which is connected to the system via local and/or long-distance networks.

An MSC is a telephone switch specialized for wireless and mobility support. An MSC performs various functions, including mobility management, call handoffs, call admission, call control, resource allocation, and so forth. The call is then relayed from the MSC to one or more base stations, via wireless communication, to the target communications device.

In FIG. 3, whenever a communications device, e.g. 304, activates or roams into a new MSC coverage area (i.e., the “cell” for which the MSC is responsible), the new MSC becomes the serving MSC 312. The communications device 304 transmits its stored identity to the new serving MSC via a base station. As shown in FIG. 3, the subscriber identity information is transmitted over a radio channel 308 and detected by an antenna of a base station. The base station, in turn, transmits the subscriber identity information to the serving MSC 312.

As illustrated in the embodiment of FIG. 3, the MSC 312 can, in some embodiments, include Visiting Location Register (VLR) functionality. VLRs are used to track subscribers within the network that are roaming out of their cell serviced by their home location register (HLR) and are presently located within the cell of the network serviced by a particular VLR and its corresponding MSC.

An HLR is a database in a cellular system that contains all the subscribers within the provider's home service area. Those of ordinary skill in the art will understand that an HLR can be a standalone device such as a server or the functionality of an HLR can be integrated into another network device, such as into an MSC or VLR effectively making the device a combined MSC/HLR or VLR/HLR device.

In order to provide mobile service to a registered mobile device 304, the serving MSC 312 transmits a signal, such as a location update signal (e.g., GSM message), to an HLR, such as HLR 316. The data in the HLR is requested and transferred to a VLR in the new area.

The transferred signal informs the HLR 316 of the network address associated with the MSC 312 currently serving the mobile device 304 and also requests requisite subscriber information for providing mobile service to the roaming mobile device 304. The HLR 316 updates its database to store the network address representing the serving MSC 312 and also copies the requested subscriber information to the VLR associated with the serving MSC 312. The network address representing the serving MSC 312 stored in the HLR 316 is later utilized by the mobile network to reroute any incoming call intended for the mobile device 304 to the serving MSC 312.

Accordingly, whenever a telecommunications subscriber dials a telephone number for the mobile device 304, the HLR 316 is queried by the mobile network to determine the current location of the mobile device 304. Utilizing the stored network address in HLR 316 representing the serving MSC 312, the HLR 316 requests a roaming number from the serving MSC 312 in response to the receipt of the query signal.

The roaming number provided by the serving MSC 312 is then used by the telecommunications network to route the incoming signal towards the serving MSC 312. The serving MSC 312 then pages the mobile device 304 and accordingly establishes a voice connection with the mobile device 304, if available. If the mobile device 304 roams out of serving MSC 312 coverage area and into another MSC coverage area, MSC 312 will hand-off the communication to the new MSC and its corresponding new base station.

Although, the use of HLRs and VLRs within the network can locate a roaming subscriber within the network, when a subscriber roams outside the network, this system cannot locate the subscriber. However, as shown in FIG. 3, embodiments of the present invention through use of a link structure can locate the subscriber and conduct communications sessions between the networks.

Embodiments of the invention provide a computing device 302 to act as a locator of a communications device on a number of networks. In the embodiment shown in FIG. 3, the requesting communications device 304 will, through the serving network 301, ask the computing device 302 to check to see if the target communications device 305 is located on the target network 303.

As shown, the computing device 302 can be an independent unit as shown in FIG. 3, or can be a part of one of the networks 301 or 303, or one of the communications devices 304 or 305. If located within a network, such as 301 or 303, the computing device 302 can be independent or can be integrated with another component of the network such as within an HLR, MSC, or other component of the network.

FIG. 3 illustrates a target communications device 305 communicating with the target network 303 having a mobile switching center (MSC) 332. As with the requesting communications device 304 of FIG. 3, whenever a target communications device, e.g. 305, activates or roams into a new MSC coverage area (i.e., the “cell” for which the MSC is responsible), the new MSC becomes the serving MSC. The communications device 305 transmits its stored identity to the new serving MSC via a base station. As shown in FIG. 3, the subscriber identity information is transmitted over a radio channel 308 and detected by an antenna of a base station. The base station, in turn, transmits the subscriber identity information to the serving MSC.

And, as described above with respect to the serving network 301, in order to provide mobile service to the registered mobile device 305, as the serving MSC 332, transmits a signal, such as a registration notification signal (e.g., IS-41 message) or location update signal (e.g., GSM message), to a home location register (HLR) 346. The data in the HLR is requested and transferred to a VLR in the new area, which may be part of an MSC, as illustrated by the MSC/VLR 332 of FIG. 3.

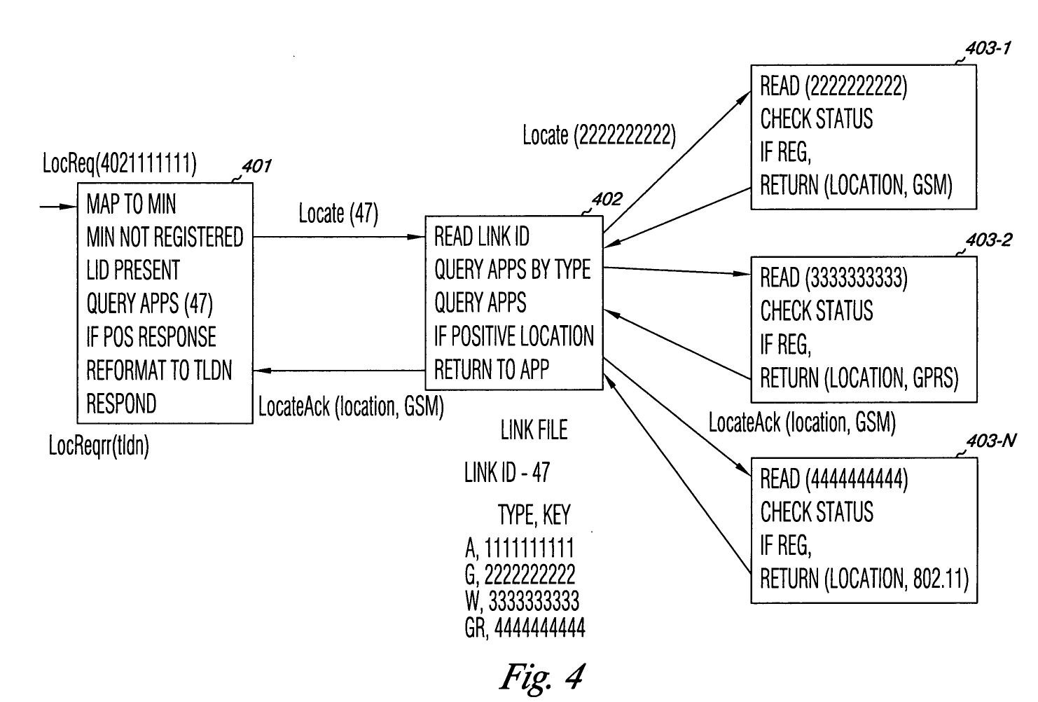

As described with the network of FIG. 3, through use of the above described components, the network 303 can track the location of a target subscriber and can locate the subscriber when a request bearing a network key associated with the subscriber is provided to the network by a requesting subscriber. This can be accomplished in the example illustrated in FIG. 3 by using the computing device 302 to access the link structure and request connection to the target device 305 based upon the network key provided in the link file and corresponding to the particular network 303 in which the target subscriber is being sought. An example of this process is described in greater detail below with respect to FIG. 4.

FIG. 4 is a scenario diagram illustrating an embodiment of the communication between a first network and a second network for locating a communications device. In the scenario illustrated in FIG. 4, program instructions execute on a requesting communications device to initiate a call by initiating a location request (e.g., LocReq (4021111111)) based upon a MDN for a target communications device. In the example shown in FIG. 4, the MDN is 4021111111.

The requesting communications device is operating in a serving network 401, such as network 301 illustrated in FIG. 3. In the illustrated case, the serving network 401 is an ANSI type network. However, the embodiments of the present invention are not so limited. The serving network 401 includes program instructions which execute to check the data on the serving network 401 to see if the MDN is registered by identifying whether the MDN is associated with a MIN (e.g., MAP TO MIN in block 401). If the MDN has an association, the network executes program instructions to attempt to connect the call.

If the call cannot be connected or there is no association, meaning that the MDN is not associated with a MIN and therefore the MIN is not registered (e.g., MIN NOT REGISTERED in block 401) in the serving network 401, then program instructions execute to check to see if a link ID is associated with the MDN or the MIN. If a link ID is associated (e.g., LID PRESENT in block 401), then the serving network 401 uses the link ID to locate the link file (e.g., Locate (47) in FIG. 4) containing the network keys associated with the subscriber. In various embodiments, the serving network 401 can also access the link file to identify the association between the MDN and the MIN on the serving network 401.

As stated above, the link ID can reference a portion of a file having information about a number of subscribers or can reference an entire file having information about the particular subscriber. The link ID can include the network type and network key for a number of networks. The network types and keys can be organized in various manners. For example, the network types and keys can be organized randomly, alphabetically, by size of network, or by likelihood that the subscriber will be in the network (e.g., in Europe, GSM and GPRS would be more likely than other network types), to name a few.

Program instructions execute on the serving network 401 or in the link structure 402 to select a network type and key from the hierarchy of network types associated with the subscriber (e.g., QUERY APPS BY TYPE in block 402) and to query the selected network to see if the subscriber is registered and accessible (e.g., QUERY APPS in block 402). In the example shown in FIG. 4, the hierarchy of network types and keys is the same as shown in FIG. 1.

In the example of FIG. 4, since the serving network 401 is an ANSI type network and the serving network 401 has been searched for the subscriber's registration and availability and since the serving network 401 checked to see if the subscriber was registered prior to accessing the link structure 402, the serving network 401 can skip the ANSI network type and key in the hierarchy, and can move to the second network type on the list (e.g., GSM).

In the example shown in FIG. 4, the link structure 402 initiates contact with the target network (e.g., second network type 403-1) by making a location request (e.g., Locate(2222222222)). An example of dialog with the second network type is illustrated in block 403-1 of FIG. 4.

In the illustrated example of FIG. 4, the GSM network 403-1 includes program instructions which execute to read the network key associated with its network type received from the link file (e.g., 2222222222). Program instructions execute on the network 403-1 to check the status of the target communications device (e.g., CHECK STATUS in block 403-1) and to return either that the device is accessible, inaccessible, or no response due to the network timing out during its search (e.g., IF REG, RETURN (LOCATION, GSM) in block 403-1). If the subscriber is accessible, then program instructions execute to return the location (e.g., (LOCATION, GSM) in block 403-1) to the link structure 402 and program instructions execute to return a location acknowledgement (LocateAck) to the serving network 401 and the call can be connected.

The connection of the call can include the assignment of a Temporary Local Directory Number (TLDN), or similar temporary identifier, for the subscriber by the serving network 401 (e.g., REFORMAT TO TLDN in block 401). A TLDN is a temporary address assigned to a subscriber when the subscriber is roaming within a network. A TLDN is used in ANSI networks; however, other networks may use other temporary identifiers. In various embodiments, the TLDN can be forwarded to the serving network 401 and to the communications device to aid in the initiation of a communications session.

If the subscriber is inaccessible, then program instructions, such as in serving network 401 and/or link structure 402 can execute to select the next network type on the hierarchy in the link file, and the next network is contacted. For example, in FIG. 4, if a no response or inaccessible response is returned from the GSM network, then program instructions execute to select the GPRS network type from the hierarchy and the GPRS network 403-2 is queried. In the example shown in FIG. 4, if the subscriber is inaccessible, then the 802.11 network type on the hierarchy in the link file is selected and contacted as shown in block 403-N.

FIGS. 5A-5D show various information in the form of tables, however, those of ordinary skill in the art will understand that the format and content of this information can be changed with respect to the various embodiments of the invention and that program instructions that can execute using program logic can be substituted for the use of the tables shown to make selections regarding network definitions, cancellation, priority, and the like.

FIG. 5A illustrates an example of a table of network types. In the example illustrated in FIG. 5A, four network types are shown and symbols are defined for use in the link file. Those of ordinary skill in the art will understand that various other network types can be used in such a table and that various symbols including the names of the network types themselves can be used to identify the network types. Additionally, in the embodiment shown in FIG. 5A, the location of each network type in a hierarchy within the link file is provided. For example, the network key for the ANSI network is indicated in the table as being positioned in location 1 of the link file.

FIG. 5B illustrates an example of a logic table for the cancellation of different network types. Cancellation is one function that the system and network level files described in FIG. 2 can provide. A cancellation table is useful when a subscriber is registered in a new network. For example, in some situations, when the subscriber is added to a new network type, the subscriber is cancelled from other networks on which the subscriber was previously registered.

In the example shown, for instance, the left side of the table represents the network type of the new registration and the top side represents whether a registration is to be canceled in a particular network. For instance, in the example shown, when a subscriber is registered in an ANSI network, other ANSI registrations, GSM registrations, and GPRS registrations are to be canceled, but the registration in the Wireless network is to be maintained. The table of FIG. 5B is exemplary and accordingly, the embodiments of the invention are not limited to include a cancellation functionality or to the cancellation logic shown therein.

FIG. 5C illustrates an example of a priority table for selection of a network type to be queried. In the example shown in FIG. 5C, the ANSI network receives the top priority and, therefore, is selected first when checking to see where a target communications device is registered. As shown, the next network type to be selected is GSM, then GPRS, and finally Wireless. The hierarchy in the illustrated example of FIG. 5C is an alphabetical hierarchy, however as stated above, the number, type, and order of network types are not limited to the example shown in FIG. 5C.

FIG. 5D illustrates examples of functions that can be utilized with a link ID. Although those of ordinary skill in the art will understand that various other and different functions can be accomplished by the system and network level files of the link structure, examples of some functions are provided in FIG. 5D. In the example provided in FIG. 5D, each of the listed instructions invokes an API that can accomplish the described tasks. For example, when the instruction Locate (LID) is initiated, an API is invoked that executes program instructions to search the link structure for the link ID, e.g., link ID 47, and access the link ID information when located.

A cancel instruction can be used to access the link ID during the cancellation of a subscriber on a network in order to cancel one or more of the network keys provided in the link structure for the particular subscriber. In this way, network types and keys for canceled registrations will not be listed in the link structure.

Likewise, a register instruction can be used during the registration process to add one or more networks by adding a network key to the link structure. Additionally, the information in the link structure can be added or edited through use of an update instruction. Further, in various embodiments, entire link files can be deleted, added, or the information within a link file can be cleared for re-entry.

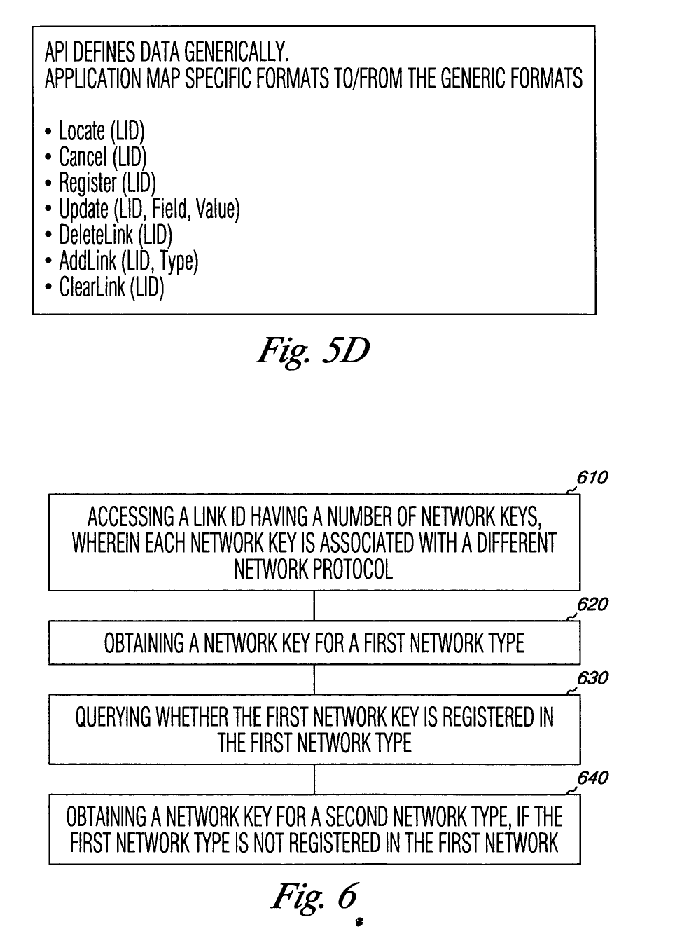

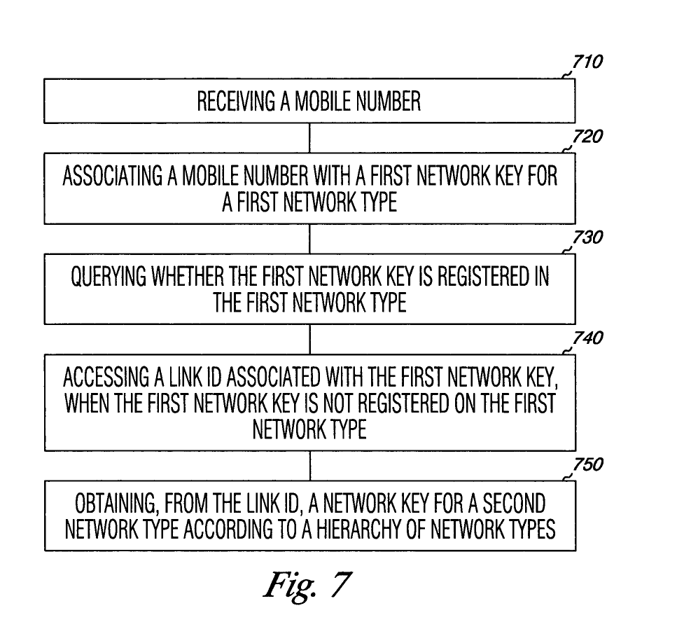

FIGS. 6 and 7 illustrate various method embodiments for wireless operation between first and second networks. As one of ordinary skill in the art will understand, the embodiments can be performed by software, application modules, and computer executable instructions operable on the systems and devices shown herein or otherwise.

The embodiments of the invention are not limited to any particular operating environment or to software written in a particular programming language. Software, application modules, and/or computer executable instructions, suitable for carrying out embodiments of the present invention, can be resident in one or more devices or locations or in several and even many locations.

Embodiments of the invention can also reside on various forms of computer readable mediums. Those of ordinary skill in the art will understand that a computer readable medium can be any medium that contains information that is readable by a computer. Forms of computer readable mediums can, for example, include volatile and/or non-volatile memory stored on fixed or removable mediums, such as hard drives, disks, memory cards, and the like, among others.

Unless explicitly stated, the method embodiments described herein are not constrained to a particular order or sequence. Additionally, some of the described method embodiments or elements thereof can occur or be performed at the same point in time.

FIG. 6 illustrates one method embodiment for wireless operation between a first network and a second network on a computing device, e.g., individual computing devices and/or a system such as the system shown in FIG. 1. As shown at block 610 in the embodiment of FIG. 6, the method includes accessing a link ID having a number of network keys, wherein each network key is associated with a different network protocol.

At block 620, the method further includes obtaining a network key for a first network type. In various embodiments, the network key can be obtained from a link ID. The link ID can include, or be, a link structure or link file containing a number of network keys. For example, the link file can include a number of network keys and network identifiers formatted in a list. The link ID can include a number of network keys and the network keys can be organized in a hierarchy. Access to the link file can be accomplished in a variety of manners, such as through use of an application program interface that includes program instructions which execute to provide a mobile number associated with the link file.

The method of FIG. 6 further includes, querying whether the first network key is registered in the first network type, at block 630. At block 640, the method further includes obtaining a network key for a second network type, if the first network type is not registered in the first network. The second network key can be obtained according to a hierarchy of keys and/or network types, as described above.

The method can include obtaining subscriber identification information from a second network if the second network key is registered on the second network type. Subscriber information can include other information such as information that can be used to identify the status, information to aid in the establishment of a wireless call to the subscriber, and/or provide information about the subscriber such as a subscriber profile and/or billing information.

For example, when a subscriber is roaming within the second network, the HLR of the second network can request a roaming number (e.g., a “Provide Roaming Number” (PRN) request in a GSM network) from the MSC/VLR of the second network. The MSC/VLR can provide the roaming number assigned to the subscriber (e.g., in a GSM network, the response can be a “Send Routing Information” (SRI) response). When the MSC/VLR responds to the HLR, it provides a reachable address that can be used to navigate the network in order to reach the subscriber. The reachable address can include the identifier of the HLR or VLR that is serving the subscriber, for example.

Embodiments of the invention can also have link structures that include subscriber location and registration status information within the link file or link structure for one or more of the networks on which a subscriber is registered. In this way, the link structure does not have to query a network to see if a subscriber is registered or if the subscriber is available.

In various embodiments, the method can include directing a wireless call based upon a response received from the first network type. For example, the call can be directed to a subscriber on a wireless device. The call can also be directed to a voice mail system based upon a response received from the first network type.

For instance, if the particular subscriber is available to receive a call, then the response received from the first network will indicate that the subscriber is available. In such a case, the call can then be directed to the subscriber, e.g., at a wireless device, such as a wireless telephone or personal digital assistant (PDA), and the like. If the subscriber is unavailable, then the call can be directed to a messaging system, such as a voice mail system and the caller can leave a message for the subscriber.

FIG. 7 illustrates another method embodiment for wireless operation between a first network and a second network on a computing device, e.g., a computing device and/or a system such as the system shown in FIG. 1. As shown at block 710 in the embodiment of FIG. 7, the method includes receiving a mobile number. The method also includes associating a mobile number with a first network key for a first network type, at block 720. At block 730, the method also includes querying whether the first network key is registered in the first network type.

The method of FIG. 7 further includes, accessing a link ID associated with the first network key, when the first network key is not registered on the first network type, at block 740. At block 750, the method also includes, obtaining, from the link ID, a network key for a second network type according to a hierarchy of network types. In various embodiments, the method can also include querying whether the second network key is registered in the second network type.

Method embodiments can also include accessing a link ID associated with the second network key, when the second network key is not registered on the second network type. Various method embodiments can also include obtaining, from the link ID, a network key for a third network type according to a hierarchy of network types.

The various embodiments of the present invention can include various network types. For example, network types can include: ANSI, GSM, general packet radio service (GPRS), EDGE, UMTS, Code Division Multiple Access (CDMA and Wireless CDMA) and 802.11 networks, to name a few.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention.

It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

1. A computing device, comprising:
a processor;
a memory coupled to the processor, the memory having a link ID associating a number of network keys that each provide access to a different network protocol for a particular subscriber; and
program instructions provided to the memory and executable by the processor to:
select a first network key from the number of network keys; and
query whether the first network key is registered in a first network type.

2. The device of claim 1, wherein the device further includes a home location register (HLR) for maintaining a list of home network subscribers including a subscriber information file for each subscriber that includes an association to one of a number of link IDs.

3. The device of claim 1, wherein the link ID includes a list of network keys for all networks accessible by a particular subscriber.

4. The device of claim 1, wherein the network keys are of various lengths.

5. The device of claim 1, wherein the link ID is accessible through use of a network key for a first network protocol.

6. The device of claim 5, wherein access through use of the network key for the first network protocol allows access to the other of the number of network keys.

7. The device of claim 1, wherein the device further includes program instructions executable to identify a status of a subscriber on a particular network.

8. A computing device, comprising:
a processor;
a memory coupled to the processor; and
program instructions provided to the memory and executable by the processor to:
receive a mobile number;
associate a mobile number with a first network key for a first network type;
query whether the first network key is registered in the first network type;
access a link ID associated with the first network key, when the first network key is not registered on the first network type; and
obtain, from the link ID, a network key for a second network type according to a hierarchy of network types.

9. The device of claim 8, wherein the device is located within an American National Standards Institute (ANSI) network type.

10. The device of claim 8, wherein the device is located within a Global System for Mobile Communications (GSM) network type.

11. The device of claim 8, wherein the device is a HLR in an ANSI network.

12. The device of claim 8, wherein the device is a HLR in a GSM network.

13. The device of claim 8, further including program instructions executable to follow a priority structure for determining which key among the number of network keys to access.

14. A computing device, comprising:
a processor;
a memory coupled to the processor; and
program instructions provided to the memory and executable by the processor to:
create a link ID record associated with a first network key for a first network protocol in the memory;
receive a second key associated with a second network protocol into the link ID record;
receive a third key associated with a third network protocol into the link ID record.

15. The device of claim 14, further including program instructions executable to access the link ID record with any of the first, second, and third keys.

16. The device of claim 14, further including program instructions executable to determine a number of networks to be canceled when a new network protocol is selected.

17. A method for wireless operation between a first network and a second network, comprising;
accessing a link ID having a number of network keys, wherein each network key is associated with a different network protocol;
obtaining, from the link ID, a network key for a first network type according to a hierarchy of network types;
querying whether the first network key is registered in the first network type; and
obtaining, from the link ID, a network key for a second network type according to the hierarchy of network types, if the first network type is not registered in the first network.

18. The method of claim 17, wherein the method further includes directing a wireless call based upon a response received from the first network type.

19. The method of claim 17, wherein the method further includes directing a call to a subscriber on a wireless device based upon a response received from the first network type.

20. The method of claim 17, wherein the method further includes directing a call to a voice mail system based upon a response received from the first network type.

21. A computer readable medium having instructions for causing a device to perform a method, comprising:
accessing a link ID having a number of network keys, wherein each network key is associated with a different network protocol;
obtaining, from the link ID, a network key for a first network type according to a hierarchy of network types;
querying whether the first network key is registered in the first network type; and
obtaining, from the link ID, a network key for a second network type according to the hierarchy of network types, if the first network key is not registered in the first network type.

22. The computer readable medium of claim 21, wherein the method further includes obtaining subscriber identification information from the second network if the second network key is registered on the second network type

23. The computer readable medium of claim 22, wherein obtaining subscriber identification information includes obtaining a roaming number.

24. The computer readable medium of claim 23, wherein obtaining subscriber identification information from the second network type includes obtaining a subscriber profile and billing information.

25. A method for wireless operation between a first network and a second network, comprising;
receiving a mobile number;
associating the mobile number with a first network key for a first network type;
querying whether the first network key is registered in the first network type;
accessing a link ID associated with the first network key, when the first network key is not registered on the first network type; and
obtaining, from the link ID, a network key for a second network type according to a hierarchy of network types.

26. The method of claim 25, wherein the method further includes:
querying whether the second network key is registered in the second network type;
accessing a link ID associated with the second network key, when the second network key is not registered on the second network type; and
obtaining, from the link ID, a network key for a third network type according to a hierarchy of network types.

27. The method of claim 25, wherein accessing a link ID includes accessing a link file containing a number of network keys.

28. The method of claim 25, wherein accessing a link ID includes accessing a link file including a number of network keys and network identifiers formatted in a list.

29. The method of claim 25, wherein accessing a link ID includes accessing a link file with an application program interface by providing a mobile number associated with the link file.

30. The method of claim 25, further including obtaining a network key corresponding to a network selected from networks including:
a Publicly Switched Telephone Network;
a Global System for Mobile communications network;
an American National Standards Institute network;
a Universal Mobile Telecommunication System network;
an Enhanced Data for Global Evolution network;
a Public Wireless Local Area Network;
an Internet Protocol network;
a General Packet Radio Service network; and
an 802.11 network.

31. A method for wireless operation between a first network and a second network, comprising;
receiving a mobile number;
associating the mobile number with a first network key for a first network type;
identifying whether the first network key is registered in the first network type based upon information within a link ID;
accessing a link ID associated with the first network key, when the first network key is not registered on the first network type; and
obtaining, from the link ID, a network key for a second network type according to a hierarchy of network types.

32. The method of claim 31, wherein associating a mobile number with a first network key includes accessing a link ID associated with the mobile number in order to associate the mobile number with the first network key.

33. The method of claim 31, wherein identifying whether the first network key is registered based upon information within a link ID includes subscriber location and registration status information.
